(19) United States
(12) Patent Application Publication
(10) Pub. No.: US 2016/0275445 A1
(43) Pub. Date: Sep. 22, 2016

(54) SCALE SYSTEM

(71) Applicant: ILLINOIS TOOL WORKS INC., Glenview, IL (US)

(72) Inventors: Luiz A. Rizzolo, West Chester, OH (US); Robert S. Davis, Tipp City, OH (US); Michael J. Nieberding, Cincinnati, OH (US)

(73) Assignee: ILLINOIS TOOL WORKS INC., Glenview, IL (US)

(21) Appl. No.: 15/064,077

(22) Filed: Mar. 8, 2016

Related U.S. Application Data
(60) Provisional application No. 62/134,057, filed on Mar. 17, 2015.

(51) Int. Cl. G06Q 10/08; G01G 23/44

(52) U.S. Cl. CPC G06Q 10/087; G01G 23/44

(57) ABSTRACT

A scale system includes a weighing scales located within a store, each weighing scale configured for weighing and pricing fresh items. Each weighing scale incorporates a discard transaction function that is configured to enable an operator to enter data regarding fresh items being discarded. Each scale includes a transaction data tracking function stores a fresh item transaction record for fresh items that are priced and fresh items that are discarded. POS terminals are located in the store, at which items being purchased from the store are scanned and paid for, and purchase transaction records from the POS terminals are collected and stored by a POS server. A scale management computer includes a transaction data collection function that obtains fresh item transaction records from each weighing scale and purchase transaction records from the POS server, enabling identification of inconsistencies between fresh item transaction records and purchase transaction records.

### TECHNICAL FIELD

This application relates generally to scales utilized in grocery stores for weighing and pricing items and, more specifically, to a scale system and method to enable tracking and/or maintaining desired inventory of perishable food items within a grocery store.

### BACKGROUND

Scales have been used in stores such as supermarkets and groceries to weigh and price food items and to generate a pricing label for such food items. A typical store includes multiple scales located in multiple perishables departments (e.g., prepared foods, deli, meat and fish and bakery), as well as scales that are incorporated into wrappers. However, the scale system has utility beyond simply weighing and pricing items, given the volume of fresh item transactions that take place at such scales.

Supply chain management is a well-developed field. In retail stores, such as grocery stores, data is typically collected from the checkout point-of-sale (POS) systems and is rectified against known inventory levels for a variety of purposes, including re-ordering of stock as needed. However, improvements are continually sought, and in the grocery store environment tracking POS transactions does not provide a complete picture of item activity within the store.

### SUMMARY

In one aspect, a scale system includes a plurality of weighing scales located within a store, each weighing scale including a weighing station, each weighing scale configured for weighing and pricing fresh items. A multiplicity of the weighing scales are configured to produce labels for fresh items that have been priced for sale, wherein each weighing scale incorporates a discard transaction function and a transaction data tracking function. The discard transaction function is configured to enable an operator to enter data regarding fresh items being discarded, including data regarding (a) fresh item identity and (b) quantity of fresh item discarded. The transaction data tracking function stores a fresh item transaction record for (a) each fresh item transaction completed at the weighing scale in which a fresh item is priced for sale and (b) each fresh item transaction completed at the weighing scale in which a fresh item is discarded, wherein each fresh item transaction record includes data identifying at least (i) fresh item identity, (ii) quantity of the fresh item involved in the transaction, (iii) fresh item price or fresh item value, (iv) transaction date, (iv) fresh item brand and (v) fresh item supplier. A plurality of POS terminals are located in the store, at which items being purchased from the store are scanned and paid for, and purchase transaction records from the POS terminals are collected and stored by a POS server in communication with the POS terminals. A scale management computer is in communication with each of the weighing scales and in communication with the POS server. The scale management computer includes a transaction data collection function that obtains fresh item transaction records from each weighing scale and purchase transaction records from the POS server, thereby enabling identification of inconsistencies between fresh item transaction records from the weighing scales and purchase transaction records from the POS server.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 shows a diagram of a supply chain management system;

FIG. 2 shows a schematic depiction of a scale; and

FIG. 3 shows an exemplary evaluation process of POS transaction data and fresh item transaction data.

### DESCRIPTION

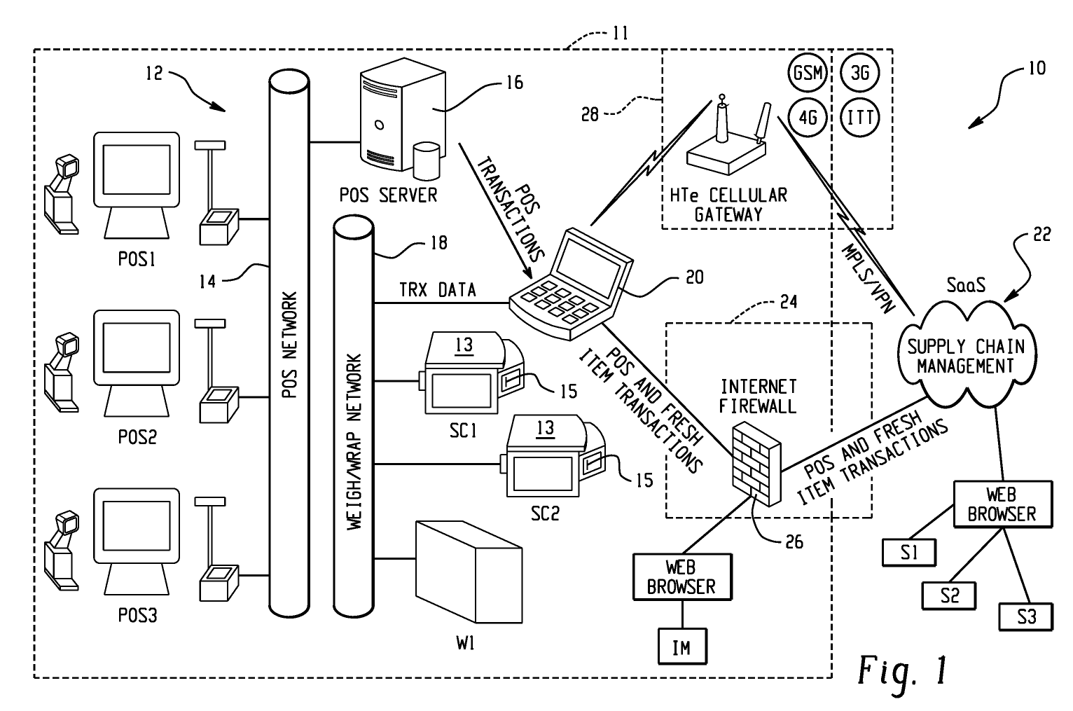

Referring to FIG. 1, a system 10 includes a plurality of weighing scales (e.g., SC1 and SC2, which could be located in a deli, meat & fish, bakery or fruit and vegetable department) located within a store 11. Each weighing scale includes a weighing station 13 and is configured for weighing and pricing fresh items (e.g., perishable food items). The weighing scales are configured to print and output labels for fresh items that have been priced for sale (e.g., where the labels are output from a label slot 15 on the scales). The system also includes a plurality of POS terminals (e.g., POS1, POS2 and POS3) at which items being purchased from the store are scanned and paid for by customers. The scales enable collection of fresh item transaction data and the POS terminals enable collection of purchase transaction data or sales transaction data.

As used herein a POS transaction or purchase transaction is considered any transaction in which a product passes through a POS as part of a customer purchase. A POS terminal or device may take the form of checkout lane manned by store personnel, such as POS1, POS2 or POS3 in FIG. 1, or could also be an unmanned checkout station such as a self-service kiosk. Moreover, for store locations where items are delivered, a POS terminal or device could take the form of a back-room or warehouse check-out/delivery station at which grouped items that are being removed from the store for delivery are scanned to account for the delivery transaction. Each POS terminal is connected to a network backbone (e.g., the POS Network backbone 14) for communication with a POS Server 16.

As used herein a fresh item transaction is considered any transaction in which a fresh food product is processed by a weighing scale or other fresh item delivery/handling device such as a wrapper device (e.g., wrapper W1 shown in FIG. 1, which could be located in the back room of a meat & fish department within the store and typically incorporates a weighing scale as well). The term weighing scale as used herein includes wrapper devices that incorporate a weighing scale. The terms weigh/wrap device and fresh item delivery/handling device as used herein include both scales and wrappers. Per FIG. 1, all of the fresh item delivery/handling devices are co-located within a grocer's facility and attached (e.g., wired or wireless) to a network backbone for communication purposes (e.g., either the POS network backbone 14 or a weigh/wrap network backbone 18).

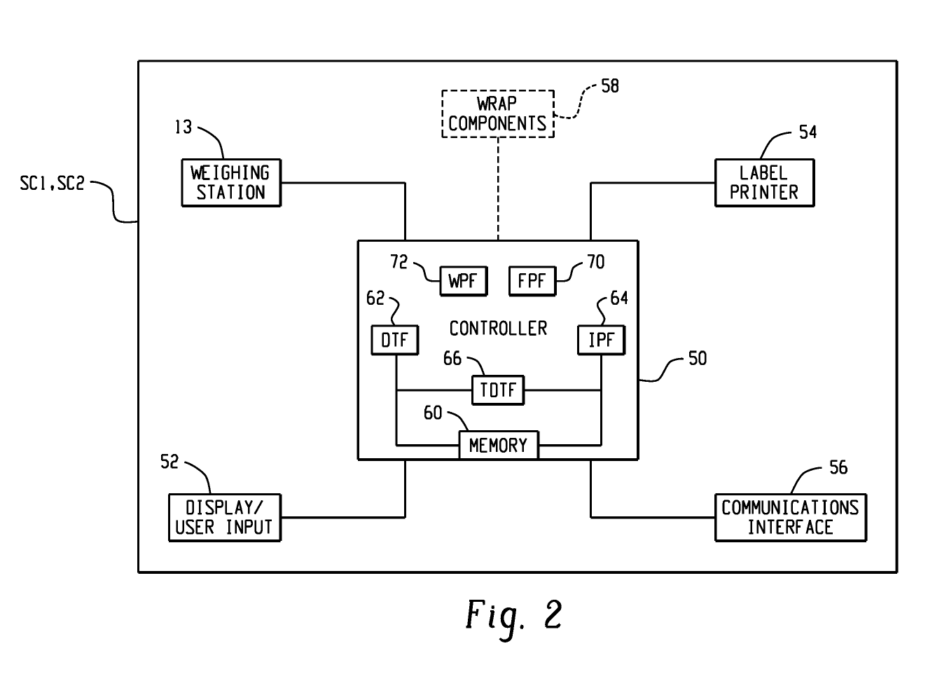

Per FIG. 2, each weighing scale includes a controller 50 connected to (i) receive load cell data from the weighing station 13, (ii) control a user interface 52 (e.g., in the form of a touch screen display, or a display and separate input keypad), (iii) control a label printer 54 and (iv) a communications interface 56 for enabling communication with other devices. Where the weighing scale is part of a wrapper, the controller may also be connected to control the wrap components 58 of the machine. The controller 50 includes memory 60 for storing information, such as product pricing and label print information needed by the scale to properly price items and print labels for the items. In addition, the controller includes a discard transaction function 62 configured to enable an operator to enter data regarding fresh items being discarded. For example, the scale interface 52 may be a touch screen interface with a selectable discard button. When an operator touches the discard button a discard screen is generated on the display that prompts that operator to input discard data, such as fresh item identification data and quantity of fresh item discarded (which may be input manually in the case of a by count item or which may be input via weighing of the item being discarded), as well as other data such as reason for the discard (e.g., item expired, item damaged etc.). The display enables an operator to complete the discard transaction by pressing a completion button.

The scale controller 50 also includes an item pricing function 64. A typical item pricing transaction by a weighing scale would involve identifying the fresh item to the scale (e.g., inputting an item code or number via the interface 52), weighing the fresh item or inputting count number for the item, establishing an item price (e.g., multiplying price-per-unit weight by the actual weight, or multiplying price per count by entered count) and printing a label to be applied to the item. The printed label typically includes a scannable bar code to facilitate checkout at a POS terminal, as well as item name/description, item price and item ingredients. When an operator selects the label print function for the pricing operation, the controller interprets the pricing transaction as being completed.

Importantly, the scale controller 50 also incorporates a transaction data tracking function 66 that stores a fresh item transaction record for each fresh item transaction completed at the weighing scale in which a fresh item is priced for sale and for each fresh item transaction completed at the weighing scale in which a fresh item is discarded. Each fresh item transaction record includes data identifying at least fresh item identity, quantity of the fresh item involved in the transaction, fresh item price or fresh item value, transaction date, fresh item brand and fresh item supplier. Operator identity (as obtained from operator login functionality of the scale) associated with the transaction may also be part of each transaction record.

Referring again to FIG. 1. purchase transaction records from the POS terminals are collected and stored by the POS server 16.

A scale management computer 20 (aka weigh/wrap device management solution) is connected to the scales SC1, SC2 and wrappers W1, and is likewise connected to the POS server 16. The scale management computer 20 includes a transaction data collection function that obtains fresh item transaction records from each weighing scale/wrapper and purchase transaction records from the POS server 16, enabling identification of inconsistencies between fresh item transaction records from the weighing scales and purchase transaction records from the POS server.

In this regard, the POS server 16 and weigh/wrap network backbone 18 are both connected to facilitate the provision of transaction data to the weigh/wrap device management computer 20. The primary function of the computer 20 is to communicate with the weigh/wrap devices (e.g., providing database updates etc.). The weigh/wrap device management solution receives or retrieves both POS purchase transaction data records from the grocer's back office POS server 16 and fresh item transaction data records from the scales and wrappers. The POS purchase transaction records will typically include data on products sold (e.g., as identified by UPC, PLU# or other number/code) with relevant additional data to include quantity, brand, supplier, price, date of sale, etc. The fresh item transaction records will typically include data on product weighed and/or wrapped (e.g., as identified by UPC, PLU# or other number/code), along with quantity (e.g., weight or number of units) of the item packaged and product label generated information (e.g., brand, supplier, price, date etc.). Voided transactions data that occur at the particular device may also be stored as fresh item transaction records. The scales and wrappers may also incorporate functionality that enables operators to load data on product waste or discard, as described above. This additional data may be included in the fresh item transaction data records delivered to the weigh/wrap device management solution 20.

All of the data regarding the various transactions are then distributed to an off-site supply chain analysis system 22, which may function as a Software as a Service system, for collection to be used for demand forecasting, planning, and replenishment calculations. In one arrangement the transaction data may be delivered from the weigh/wrap device management solution 20 to the supply chain analysis system 22 via an Internet connection 24 through a firewall 26. In an alternative arrangement the transaction data may be delivered from the weigh/wrap device management solution 20 to the supply chain analysis system 22 via a cellular gateway 28.

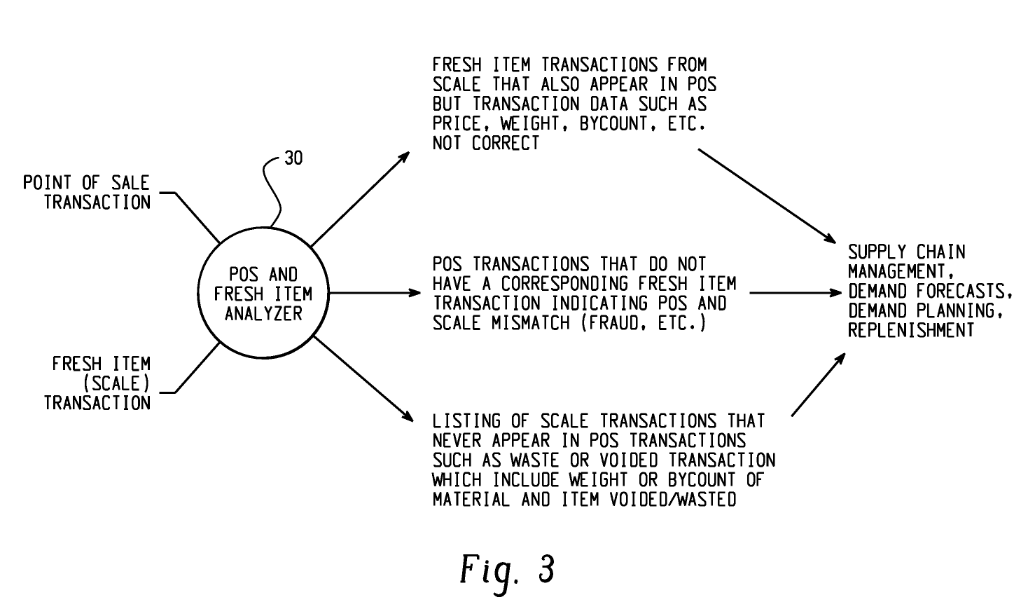

The combination of fresh item transaction records with purchase transaction records provides a unique supply chain management solution for grocers that need cross check of product sold within the POS and product handling at scale and wrap devices. As indicated in FIG. 3, the supply chain analysis system 22 may include a POS and fresh item analyzer 30 that is able to rectify (1) fresh item transactions from scales/wrappers that also appear as POS transactions, but where some data is not correct in the POS transaction, (2) POS transactions for fresh items that do not have a corresponding fresh item transaction (which could indicate fraud) and (3) fresh item transactions that never appear as POS transactions (such as shrink or waste, or voided transactions). Use and analysis of all of this data collectively improves demand forecasting, demand planning and item replenishment for the store.

In the case of fresh item transactions from scales/wrappers that also appear as POS transactions, but where some data is not correct in the POS transaction, specific actions can be taken by the system, such as generation of error reports and/or notifications.

In the case of POS transactions that do not have a corresponding fresh item transaction, specific actions can be taken by the system, such as generation of error reports and/or notifications. In some embodiments, the scales/wrappers may receive such notifications. In this regard, one or more of the scales/wrappers may include a fraud prevention function 70. In one implementation, responsive to the scale/wrapper receiving a fraud detection message/notification that includes operator identity data, the fraud prevention function 70 initiates an operator lockout that prevents the operator login functionality of the scale from logging in the operator associated with the operator identity data. In another implementation, responsive to the scale/wrapper receiving a fraud detection message/notification that includes operator identity data and fresh item identity data, the fraud prevention function 70 generates a fraud alert message when the operator associated with the operator identity data initiates a product pricing transaction at the weighing scale for the fresh item corresponding to the fresh item identity data. The fraud alert message may be sent by the scale via the communications interface to any desired location (e.g., store manager computer or mobile device).

The supply chain analysis system 22 may also generate reports and/or notifications regarding excessive waste. Again, in some embodiments the scales/wrapper may receive such notifications. In this regard, one or more of the scales/wrappers may include a waste prevention function 72. In one implementation, responsive to the scale/wrapper receiving a waste detection message/notification that includes operator identity data, the waste prevention function initiates a discard lockout that prevents the discard transaction function from allowing the operator associated with the operator identity data from completing a discard transaction. Alternatively, the waste prevention function may issue a waste alert message/notification.

An important point in the above system is the inclusion of both POS or purchase transaction data (from store POS systems) and fresh item transaction data (from store scales and wrappers) into the data that is used for supply chain forecasting, planning and replenishment. The supply chain system can thereby identify potential shrink, waste and/or fraud associated with the perishable food items.

As suggested in FIG. 1, demand forecasting, demand planning and replenishment of perishable food items is facilitated. Personnel, such as an inventory manager IM at the store or suppliers S1, S2, S3 can access the supply chain management system 22. By way of example, an inventory manager may access the system in order to check the inventory at the store. A supply coordinator at the supplier may access the system 22 in order to assure that any items, including fresh items, requiring resupply at the store are timely delivered.

It is to be clearly understood that the above description is intended by way of illustration and example only, is not intended to be taken by way of limitation, and that other changes and modifications are possible.

What is claimed is:

1. A scale system, comprising:
a plurality of weighing scales located within a store, each weighing scale including a weighing station, each weighing scale configured for weighing and pricing fresh items, a multiplicity of the weighing scales configured to produce labels for fresh items that have been priced for sale, wherein each weighing scale incorporates:
a discard transaction function configured to enable an operator to enter data regarding fresh items being discarded, including data regarding (a) fresh item identity and (b) quantity of fresh item discarded;
a transaction data tracking function that stores a fresh item transaction record for (a) each fresh item transaction completed at the weighing scale in which a fresh item is priced for sale and (b) each fresh item transaction completed at the weighing scale in which a fresh item is discarded, wherein each fresh item transaction record includes data identifying at least (i) fresh item identity, (ii) quantity of the fresh item involved in the transaction, (iii) fresh item price or fresh item value, (iv) transaction date, (iv) fresh item brand and (v) fresh item supplier;
a plurality of POS terminals at which items being purchased from the store are identified and paid for, wherein purchase transaction records from the POS terminals are collected and stored by a POS server in communication with the POS terminals;
a scale management computer in communication with each of the weighing scales and in communication with the POS server, the scale management computer including a transaction data collection function that obtains fresh item transaction records from each weighing scale and purchase transaction records from the POS server, enabling identification of inconsistencies between fresh item transaction records from the weighing scales and purchase transaction records from the POS server.

2. The scale system of claim 1, wherein the scale management computer is configured to send both the fresh item transaction records and the purchase transaction records to an off-site supply chain analysis system that in turn is configured to:
(1) identify fresh item transaction records that have corresponding purchase transaction records, but where some transaction data in the purchase transaction record is inconsistent with transaction data of the fresh item transaction record,
(2) identify purchase transaction records for fresh items that do not have a corresponding fresh item transaction record; and
(3) identify fresh item transaction records that do not have a corresponding purchase transaction record.

3. The scale system of claim 1, wherein the scale management computer is configured to send both the fresh item transaction records and the purchase transaction records to an off-site supply chain analysis system that in turn is configured to evaluate one or more of fresh item shrink, fresh item waste and/or fresh item fraud and to generate fresh item inventory management requests that take into account such fresh item shrink, fresh item waste and/or fresh item fraud.

4. The scale system of claim 2 wherein one or more of the weighing scales includes operator login functionality and a fraud prevention function, wherein, responsive to the weighing scale receiving a fraud detection message that includes operator identity data, the fraud prevention function initiates an operator lockout that prevents the operator login functionality from logging in the operator associated with the operator identity data.

5. The scale system of claim 2 wherein one or more of the weighing scales includes operator login functionality and a waste prevention function, wherein, responsive to the weighing scale receiving a waste detection message that includes operator identity data, the waste prevention function initiates a discard lockout that prevents the discard transaction function from allowing the operator associated with the operator identity data from completing a discard transaction.

6. The scale system of claim 2 wherein one or more of the weighing scales includes operator login functionality and a fraud prevention function, wherein, responsive to the weighing scale receiving a fraud detection message that includes operator identity data and fresh item identity data, the fraud prevention function generates a fraud alert message when the operator associated with the operator identity data initiates a product pricing transaction at the weighing scale for the fresh item corresponding to the fresh item identity data.

7. A store transaction system, comprising:
a plurality of weigh/wrap devices within the store, each weigh/wrap device configured for pricing fresh items for sale within the store, one or more of the weigh/wrap devices producing pricing labels for application to fresh items that have been priced;
a plurality of point-of-sale checkout devices within the store for identifying items being purchased by customers from the store;
a data collection system for collecting purchase transaction data from the point-of-sale checkout devices and for collecting fresh item transaction data from the weigh/wrap devices; and
a supply chain analysis system for receiving the purchase transaction data and the fresh item transaction data from the data collection system, the supply chain analysis system configured to compare purchase transaction data for fresh items and fresh item transaction data to identify differences between the two and take into account such differences for the purpose of inventory management of the fresh items.

8. The store transaction system of claim 1 wherein the supply chain analysis system is configured to evaluate one or more of shrink, waste and/or fraud associated with the fresh items and to take into account such shrink, waste and/or fraud for the purpose of inventory management of the fresh items.

9. The store transaction system of claim 8 wherein the supply chain analysis system is configured to provide reports for one or more of shrink, waste and/or fraud associated with the fresh items.

10. The store transaction system of claim 9 wherein the reports are accessible online to a store inventory manager.

11. The store transaction system of claim 7 wherein the data collection system comprises a weigh/wrap device management solution that receives fresh item transaction data from a weigh/wrap network and receives purchase transaction data from a back office server associated with the point-of-sale checkout devices through a point-of-sale network.

12. A method of identifying potential shrink, waste and/or fraud in the production and sale of quantities of perishable food items, the method comprising:
creating fresh item transaction data for perishable food items that are priced within a store by one or more scales and/or wrapping devices located in the store;
creating purchase transaction data for perishable food items that are purchased by customers at one or more point-of-sale checkout devices within the store;
collecting both the fresh item transaction data and the purchase transaction data for the perishable food items; and
identifying one or more discrepancies between the purchase transaction data and the fresh item transaction data.

13. The method of claim 12 including identifying store personnel associated with fresh item transactions that have discrepancies with the purchase transaction data.

14. The method of claim 12 including identifying instances of potential waste occurring with one or more perishable food items for which fresh item transactions have discrepancies with purchase transaction data.

15. The method of claim 12 including identifying instances of potential shrink occurring with one or more perishable food items for which fresh item transactions have discrepancies with purchase transaction data.

16. The method of claim 12 including ranking perishable food items according to level of discrepancy between fresh item transaction data for the perishable food item and purchase transaction data for the perishable food item.

17. The method of claim 12 wherein the identified discrepancies are utilized to adjust resupply for one or more perishable food items.

18-19. (canceled)
